(19) United States
(12) Patent Application Publication
(10) Pub. No.: US 2013/0029644 A1
(43) Pub. Date: Jan. 31, 2013

(54) Voicemail management system for mobile phone voicemail

(71) Applicant: Collin Murphy, Tamarac, FL (US)

(72) Inventor: Collin Murphy, Tamarac, FL (US)

(21) Appl. No.: 13/136,304

(22) Filed: Jul. 28, 2011

(51) Int. Cl. H04W 4/00

(52) U.S. Cl. 455/413

(57) ABSTRACT

A voicemail management system for mobile phone voicemail VM includes management operations for deleting a VM stored in a VM database of a VM recipient (M2) or a server in communication with it, upon the occurrence of a selectable time including prior to its listening or opening of VM by M2; and for forwarding a VM message stored in a user (M1) database of a mobile phone or from a server in communication with it, to the VM of M2.

### BACKGROUND OF THE INVENTION

### Field of the Invention

The systems and method herein relate to management of voicemail messages in mobile phones for which a variety of manipulations of voicemail messages in both the user and recipient mobile device may be accomplished.

The present invention relates to a voicemail mobile phone application that provides users that have downloaded the application onto their mobile phone with a variety of capabilities.

The prior art has addressed the manipulation of voicemail messages to only a limited extent. For example, U.S. Pat. No. 5,003,575 (1991) to Chamberlin et al, entitled Method and Apparatus for Storing and Forwarded Voice Signals with Controlled Access, reflects the classic or legacy technology of storing and forwarding voicemail data but which includes restrictions upon an user's ability to forward received messages to non-recipients, this in non-mobile phone applications. The reference to Chamberlin also teaches a method by which a user may limit a recipient's ability to store or forward a received voicemail until the recipient has first responded to the originator of the voicemail.

U.S. Pat. No. 6,928,149 (2005) to Panjwani teaches a voicemail management system for sending and receiving a voicemail in the form of an electronic document, arranging the same in files and, s desired, adding a note or profile to a message that is placed into a voicemail file.

U.S. Pat. No. 7,561,679 (2009) to Kalbag, entitled Message Delivery System Using a Voicemail System, reflects a system by which users may categorize messages received and by which the same message may be forwarded to multiple recipients as, for example, may be of interest in a commercial context. Kalbag also teaches that expiration dates may be associated with forwarded messages to effect their automatic deletion if not earlier deleted by the recipient.

More recently and, particularly, in early 2011, an application by the name of TIGERTEXT appeared for use in texting between mobile phones in which the sender is able to select an expiration time or date for a forwarded text message.

Apart from the above art, no voicemail mobile phone application is believed to exist which enables a user (M1) to delete a voicemail (VM) stored in a VM database of a recipient (M2) or on a server in communication therewith, after passage of a selectable time, such time selectably including prior to the listening or opening of said VM by M2, or to forward a VM message stored in the mobile phone of M1 or upon a server in communication therewith to the VM database of M2. The present invention therefore addressees a need in the art for a multi-user voicemail application suitable to the needs of the contemporary mobile phone and users thereof.

### SUMMARY OF THE INVENTION

A voicemail management system for mobile phone voicemail VM includes management operations for deleting a VM stored in a VM database of a VM recipient (M2) or a server in communication with it, upon the occurrence of a selectable time including prior to its listening or opening by M2; and for forwarding a VM message stored in a user (M1) database of a mobile phone or from a server in communication with it, to the VM of M2:

It is an object of the invention to provide a voicemail management system for mobile phone voicemail (VM) which includes management operations for deleting a VM stored in the VM database of a recipient M2 upon the occurrence of a selectable time, such time including prior to the listening or opening of the forwarded VM by M2.

It is a another object to provide a voicemail management system for forwarding VM stored in an application user's (M1) database of his mobile phone to the VM database of M2.

It is a further object of the invention to provide a capability of deleting picture and video attachments to a forwarded VM.

It is a yet further object of the invention to provide a voicemail management system for notification of the user (M1) of a recipient (M2) status of a voicemail received from M1.

It is another object to provide a capability of recording a phone call of M1 in the form of a voicemail storable within the VM database of M1.

It is a yet further object of the invention to retrieve or delete already forwarded VM from M1 before the same has been opened by the M2 recipient.

The above and yet other objects and advantages of the present invention will become apparent from the hereinafter set forth Brief Description of the Drawings, Detailed Description of the Invention and Claims appended herewith.

### BRIEF DESCRIPTION OF THE DRAWINGS

FIG. 1 is a block diagrammatic overview of the present voicemail mobile phone application.

FIG. 2 is a block diagrammatic view showing the use of options A, B and E from the “select a category” block of FIG. 1.

FIG. 3 is a block diagrammatic view of option C of the present system.

FIG. 4 is a block diagrammatic view of option D of the present system which may link back to the functions of FIG. 2.

### DETAILED DESCRIPTION OF THE INVENTION

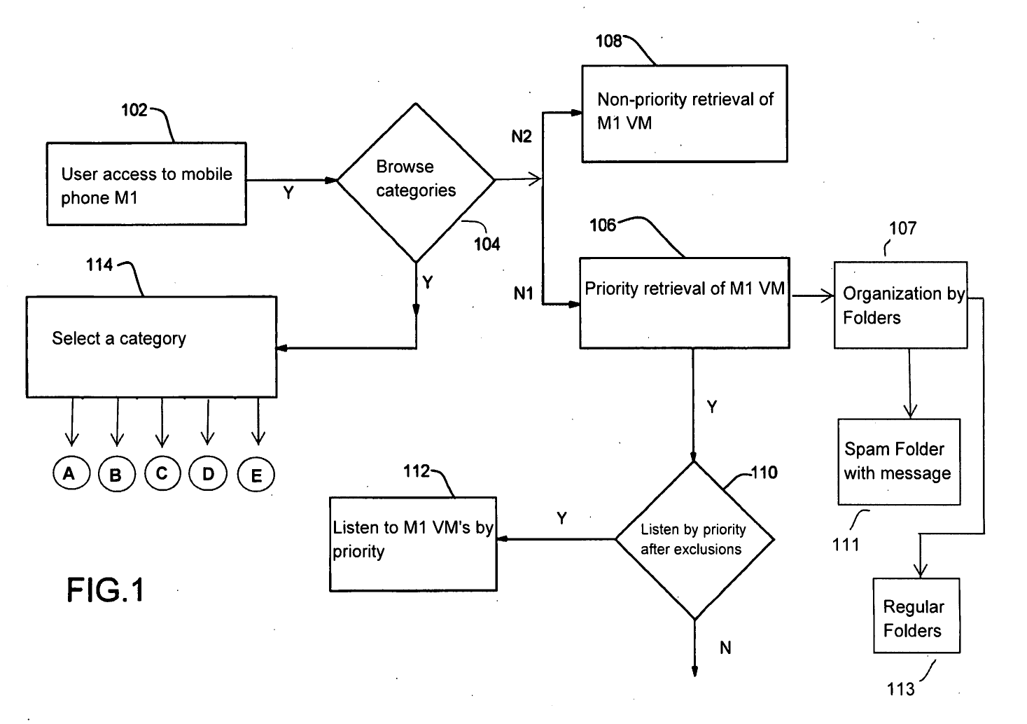

With reference to the flow chart of FIG. 1, a first mobile user (M1) is prompted to open the instant application, this indicated by box 102. If M1 chooses to open the application, he is then led to a decision point indicated by diamond 104 by which he may browse categories. Therefrom the user may choose to select a category (block 114) having particular functions A to E more fully described below, or may proceed to the right of diamond 104 to either line N1 to a retrieval of his voicemail (VM) messages in accordance with a priority arrangement 106 thereof or may proceed along line N2 to access his VM messages on a non-priority basis, indicated by block 108. If the user chooses to review the messages on a priority basis, he may then choose to listen to such priority messages after blocked messages have been excluded, this indicated by line Y to diamond 110 and function block 112, corresponding to the listening of priority VMs on the phone of M1 after exclusion of messages received from blocked phone numbers.

The feature of block 106 operates as follows:

User's of the application are able to create folders 107 to store phone numbers, similar to the way a person creates folders to organize emails. Each Incoming call will be handled according to the folder it has been assigned by the person one is calling. <Example 1: Jill creates a SPAM folder with the application. and she does not know how to tactfully tell them that they are draining her and she would rather not take their calls. Further when Jill does not answer their calls, they leave long messages that eats up her minutes just listening to them. Jill decides to place these contacts in her newly created SPAM folder III. Thereafter when anyone in her SPAM folder calls her, they automatically get a message that states: “The mobile user you have called has designated your calls to be draining/unimportant/annoying and as such your number has been assigned to my SPAM folder. Sorry but callers designated for SPAM cannot leave a voicemail for this user. Thanks for calling and goodbye.” Disconnect. There are many folders 113 the user can create to save time and create efficiency when dealing with phone calls.

With further reference to “select a category” block 114, one may proceed to either of five selections, namely:

A. forwarding a VM message stored in a user's database in his mobile phone or stored within a server in communication therewith.

B. deleting a VM message, optionally inclusive of an image associated therewith, stored in a VM database of a recipient (M2) or server in communication therewith, upon the occurrence of selectable time after sending of the VM from M1 to the recipient M2.

C. notification of M1 upon the opening or listening thereof by the recipient M2.

D. recording any outbound call of a user as a VM message upon M1's phone or as a media file upon a computer associated with M1.

E. deletion of a VM sent by M1 before M2 has opened it.

It is to be understood that, in the instant application, an original voicemail may originate from any phone, mobile or landline, regardless of whether or not the voicemail originating phone is provided with the application set forth herein.

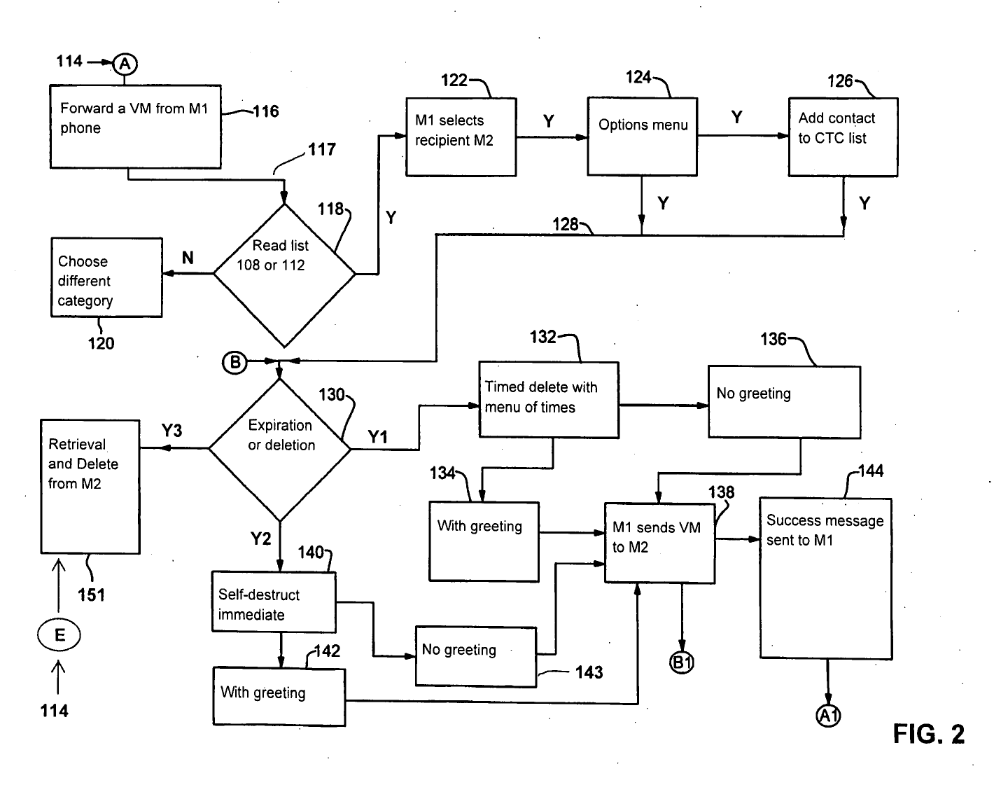

Within “select category” block 114, M1 selects option A, as the same is shown in the upper left portion of FIG. 2. Or, one may elect to then choose completely different category, i.e., B through E, which is indicated by block 114 in FIG. 1. From the selection of option A, one proceeds to block 116 which enables forwarding of a VM which is on the M1 phone. Therefrom, proceeding downward along line 117, one reaches diamond 118 from which M1 may select a recipient M2 from one of said lists 108 or 112. Doing so brings one to an options menu 124 from which one may either add a contact to one's contact list, noted by block 126, or may proceed directly to line 128 which leads to diamond 130 that relates to expiration or deletion options which may be attached to or with a given VM provided by M1 to M2. However, should one wish to opt out of the expiration/deletion point 130, one may proceed back to block 132.

In the most common form of usage of the instant system, one will proceed along either line Y1 or Y2 from diamond 130. That is, one may proceed either along line Y1 in order to format a timed expiration of a M1 VM, indicated by block 132, or may proceed along line Y2 to an immediate self-destruct function 140. Should one elect to proceed with a timed expiration or deletion to block 132, one may record and attach a greeting or message to the forwarded VM (block 134) or may choose not to attach any reading or message of any type to the forwarded VM (block 136).

The same greeting or attached message options are also available in the event that one selects the immediate self-destruct option for the forwarded VM, i.e., block 142 corresponding to a forwarded VM provided with a greeting or message, or to block 143 relating to such a forwarded immediate destruct message having no message or greeting attached therewith. In any event, all of the above set forth Category B options eventually lead to function block 138 which corresponds to the sending a VM from the phone of M1 to the phone of M2. Therefrom, V1 indicates that M2 is to receive the VM sent from M1. M2 will then access his VM menu to listen to M1's forwarded VMs. However, before M1's VM begins to play, it advises M2 that this VM will self-destruct X minutes after it plays (if X minutes is the selected time period for self-destruction). Otherwise, another timeframe, whether immediate or longer or shorter than five minutes, will also be heard by M2 before the forwarded VM begins to play. M2 then listens to the VM received from M1 and a running timer (except in the case of immediate self-destruct) appears counting down the expiration of the VM. When the timer counts down to zero, the VM self-destructs.

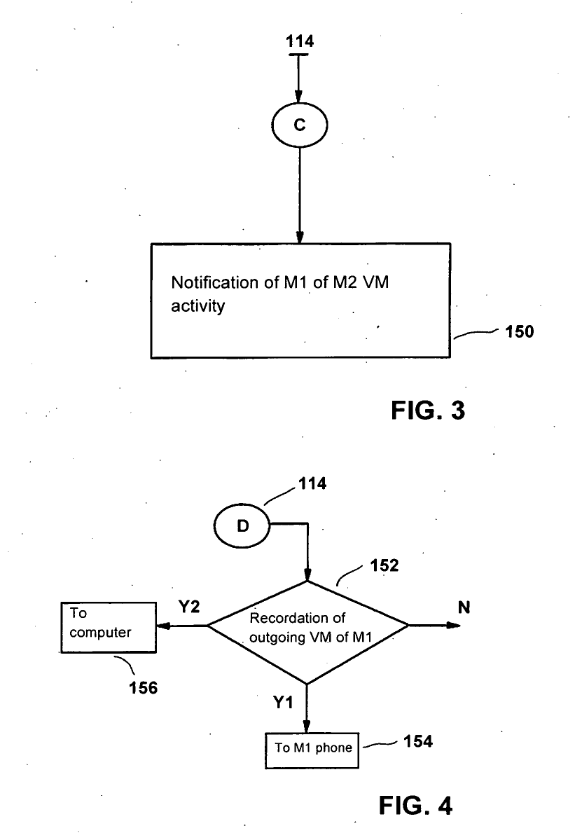

As is shown by block 144, M1 is notified when his message has been received by M2. Thereafter, as is indicated by A1 beneath block 144, M2 will eventually access his VM menu to listen to M1's messages, whether it is a VM of M1 himself or that of a third party that originated the VM to M1. However, before M1's VM begins to play, M2 is advised this VM will self-destruct after it plays if the self-destruct function 140 has been employed after deletion from M2's phone, M1 is notified that M2 has listened to his message and that his message has self-destructed. See FIG. 3.

In the timing function, per block 132, a menu will appear which includes select expiration date or an option to hit “okay without expiration date” in the event that the user inadvertently wanders from branch B of block 114 of the application (see FIG. 1). The user will then select an expiration date through the use of a menu with a drop down of minutes, hours, weeks or days, until the desired expiration. If the user selects minutes, a menu will prompt the user to enter a number from 0 to 60, and so forth as to hours, weeks and days, with a maximum expiration of 30 days. If, in one example, the user chooses five minutes the VM self-destructs five minutes after it is listened to.

The greeting option, after block 132 or 140, is indicated by blocks 134 and 142 respectively. Therefrom, a greeting may be selected from an options menu of greetings or messages, or M1 may, upon a prompt, dictate his own message to be attached to the forwarded VM.

It is noted that block 151 may be accessed from diamond 130, using line 1/3, if M2 decides to delete a message forward to M2 before it is heard.

Shown in FIG. 3 is the selection of option C out of “selected category” block 114 of FIG. 1. Option C of FIG. 3, indicated by block 150, represents a channel by which M1 is notified of any activity which occurs on M2 relative to a VM which M1 has forwarded. In other words, anything which M2 may do with a message of M1 that is forwarded, may, using any of the data manipulations described with reference to FIGS. 1 and 2, be transmitted by text, email, or automated phone call to M1. Therefrom, one may return to block 102, shown in FIG. 1.

With reference to function block 151 of FIG. 2 is reachable from both expiration or deletion diamond 130 as above noted, by following the path marked Y3 or one may retrieve and delete games, videos, pictures or other data left or forwarded to a recipient M2 prior to the initiation of self-destruct function or before the immediate self-destruct function of blocks 132 or 140, this by using option E off of block 114. As an example of the use of this retrieval delete feature, one may use the same to delete a VM or any attachment associated therewith which M1 becomes regretful of having sent in the first place, because of damage it might cause to M1, M2 or both. In other words, the retrieval delete function 151 represents an override of timed delete function 132 and self destruct upon listening function 140. That is, on a given occasion, one may wish to employ the present application for the sole purpose of deleting an email previously forwarded, whether in a conventional fashion, with a picture or video attached thereto, or in a timed or immediate self-destruct fashion as above described.

Shown in FIG. 4 is Option D of function 152 of the present system of recording an outgoing message of M1 in the form of a voicemail (branch Y1) of FIG. 4 stored within the voicemail of the phone of M1 (block 154) or, if branch Y2 is selected, on computer file upon a computer or server of M1.

In summary, the present application provides programs and options as above described providing the following features:

Voicemail forwarding;

Voicemail self-destruct at any time, whether or not accessed by recipient.

Video self-destruct;

Still picture self-destruct;

Notification of recipient status of voicemail;

Retrievable messages by priority.

Record call of M1 as a VM for later use or review.

While there has been shown and described above the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the claims appended herewith.

Having thus described my invention, what I claim as new, useful, and non-obvious and, accordingly, secure by Letters Patent of the United States is:

1. A voicemail management system for mobile phone voicemail VM including management operations comprising:
means for deleting a VM stored in a VM database of a VM recipient (M2) or a server in communication therewith, upon the occurrence of a selectable time including prior to the listening or opening thereof of said VM by M2.

2. The system as recited in claim 1, further comprising:
means for forwarding message stored in a user (M1) database of a mobile phone or from a server in communication therewith, to the VM of M2.

3. The system as recited in claim 2, further comprising:
means for attaching a message in greeting to said VM sent from M1.

4. The system as recited in claim 1, further comprising:
means for timing by M1 of the deletion of said VM from M2.

5. The system as recited in claim 2, further comprising:
means for timing by M1 of the deletion of said VM.

6. The system as recited in claim 3, further comprising:
means for timing by M1 of the deletion of said VM from M2.

7. The system as recited in claim 2, further comprising:
means for notification of a sender M1 upon the opening or listening of a VM of M1 thereof by M2;

8. The system as recited in claim 2, further comprising:
means for recording any outbound call of the user as a VM on M1's mobile phone or as a media file upon an M1 associated computer.

9. The system as recited in claim 2, further comprising:
means for organizing incoming VM's by file category and priority in designating category specific greetings therefore when a VM is received by M1.

10. The system as recited in claim 5, further comprising:
means for attaching an image to a VM sent by M1 to M2.

11. The system as recited in claim 9, further comprising:
means for blocking undesirable VMs received by M1 from a selectable phone number.

12. The system as recited in claim 11, further comprising:
a message delivered to the origin of each blocked message.

13. The system as recited in claim 9, further comprising:
means for blocking phone calls received from selectable phone numbers.

14. The system as recited in claim 13, further comprises:
means for blocking phone calls received from selectable phone numbers.
